(19) United States
(12) Patent Application Publication
(10) Pub. No.: US 2005/0017629 A1
(43) Pub. Date: Jan. 27, 2005

(54) Light emitting devices based on hyperbranched polymers with lanthanide ions

(75) Inventors: Alexei Vitukhnovsky, New Haven, CT (US); Sergei Krivoshlykov, Shrewsbury, MA (US)

Correspondence Address: Dr. Sergei Krivoshlykov;ALTAIR Center, LLC, 1 Chartwell Circle, Shrewsbury, MA, 01545, US

(73) Assignee: ALTAIR Center, LLC.

(21) Appl. No.: 10/625,301

(22) Filed: Jul. 22, 2003

(51) Int. Cl. H05B 33/14; H05B 33/00

(52) U.S. Cl. 313/504; 313/503; 428/690

(57) ABSTRACT

The present invention describes new organic light emitting devices (OLED) based on dendritic and hyperbranched materials with cascade, tree-like architecture. It suggests special design of highly emissive dendrimers with lanthanide (Ln³⁺) ions (for example, Eu³⁺/Tb³⁺) in their core providing efficient light harvesting similar to bacteriorhodopsine and other natural photosynthetic systems. The proposed design has a number of advantages with respect to known electro-luminescence devices. Color of the light emission can be controlled by proper selection of the core, whereas special surface groups can provide good solubility of the material, which is extremely important for spin cast fabrication of the sandwich devices. In order to prevent lanthanide (Ln³) aggregation leading to self-quenching processes the Ln³⁺ ions are surrounded by dendritic shell. The dendritic branches are designed such to have a HOMO-LUMO energy gap near 4f energy level of the lanthanide core, providing a vectorial charge and exciton transport towards the light emitting center placed in the dendritic core. The energy transfer by the Dexter energy exchange mechanism from triplet states of the periphery to Ln³⁺ core ensures high light emitting efficiency of the device. The invention can be used in all applications where highly efficient and flexible organic multicolor (red, green, blue) or white light emitting OLED devices are required, including highly efficient color displays for computers, TVs and mobile phones, as well as devices for signal processing and general lighting applications.

### BACKGROUND OF THE INVENTION

1. Field of the Invention

The present invention relates to organic light emitting devices, such as polymer light emitting diodes, organic color displays, and, in particular, to a new highly efficient organic light emitting materials based on dendrimers and hyperbranched polymers with lanthanide ions.

Active light emitting layer of the organic light emitting device in the preferred embodiment of this invention is fabricated form special dendritic and hyperbranched materials with cascade, tree-like architecture having lanthanide (Ln³⁺) ions (for example, Eu³⁺ or Tb³⁺) in the core providing efficient light harvesting similar to bacteriorhodopsine and other natural photosynthetic systems. Said dendritic and hyperbranched material has special smart design, which includes hierarchic architecture allowing to use effectively triplet levels and enhance light emitting performance of the device by taking advantage of at least one of the following physical effects or their combination: the antenna effect, the shell effect, and the effect of energy transfer from the periphery to Ln³⁺ locus.

These materials can be used in all applications where highly efficient and flexible organic multicolor (red, green, blue) or white light emitting OLED devices are required, including highly efficient color displays for computers, TVs and mobile phones, as well as devices for signal processing and general lighting applications.

2. Description of the Prior Art

Organic light emitting diodes (OLEDs) based on low molecular weight and polymeric materials are in an advanced stage of application in flat panel displays. After the first reports of Tang and VanSlyke in 1987 and Burroughes et al. in 1990 rapid progress was achieved in optimization of the device parameters such as efficiency and brightness. However, in spite of these successful developments, new OLEDs with improved reliability and performance are still in demand.

In OLEDs luminescence is generated by recombination of electrons and holes injected into organic material of the active layer. Recombination of electrons and holes in the active layer yields the singlet or triplet excited states at the recombination centers. Efficient injection process requires molecules with the low-lying antibonding and the high-lying bonding orbitals. Usually, these are π-orbitals in aromatic moieties. The organic active layer can be produced from electroconductive polymer, e.g. poly-phenylene-vynilene (PPV) or can consist of “small” molecules, like tris-hydroxy-quinoline aluminum (AlQ₃). The polymer layer can be prepared by spin coating; “small” molecules can be settled using vapor deposition or spin coating.

There are three different ways, in which recombining electron and hole can form an overall triplet state at the recombination center (quantum numbers I_{Z}=−1, 0 and +1) and one way to form a singlet state (quantum number I_{Z}=0) (FIG. 1). If follows from spin statistics that three times as many triplets as singlets are formed, so the quantum efficiency of a OLED cannot be more than 25% for regular materials. This limit would be reached when every exciton in a singlet state emitted a photon, and when every pair of electrons and holes was captured perfectly. The highest efficiency so far obtained is 10%, which occurs when only half the singlets emit photons and not every electron captures a hole perfectly. This efficiency is already too high to be explained by a model that assumes that three triplets are formed for every singlet. It therefore seems likely that new models will be needed to explain how OLEDs operate, possibly involving spin-dependent electron-hole capture of the triplet exciton population. Considering the spin statistics for an exciton formed by non-geminate pair combination, one would expect that the electroluminescence yield from a triplet state would be tripled if both singlet and triplet states have the same photoluminescence yield. This provided a possibility to surmount the 25% limitation of the electroluminescence quantum yield. The key issues were to lift the ban of spin forbidden transitions of the luminophore, to find triplet materials with high emission quantum efficiency, and also to investigate their suitability for fabrication of the electroluminescence device.

In the host-guest systems molecules with large fluorescent quantum yield and oscillator strength are incorporated at low concentration (<5% w/w) in the transport material. Under these conditions the excitation transfer can take place as the result of Coulomb interactions (Förster transfer). These excitations can be transferred on the distances higher than 50 Å and high quantum yields can be obtained for the acceptor molecules.

Dendrimers are three-dimensional synthetic molecules, which incorporates repetitive branching sequences (FIG. 2) to create unique architecture. Exceptional features of the dendritic architecture include high degree of structural symmetry, density gradient displaying an intra-molecular minimum value and well-defined number of terminal groups. Combination of these features creates an environment within the dendrimer molecule facilitating development and manufacturing of reliable and economical functional nanoscale materials with unique properties that could form the basis for new nanoscale devices and novel technologies.

Synthetic procedures, developed for dendrimers preparation, permit nearly complete control over the critical molecular design parameters, such as size, shape, surface/interior chemical structure, flexibility, and topology. Synthesis techniques provide effective routs to the dendrimer structures, including the Starburst divergent strategy (Tomalia and coworkers), the convergent growth strategy (Fréchet and coworkers), and the self-assembly strategy (Zimmerman and coworkers). These methods have proved to be effective in generating macromolecules with unique combination of properties. Over the last decade synthesis of novel dendrimers has been a very active area of research, and one interesting aspect was the introduction of various functional cores. The subject of this invention is specially designed dendrimers with lanthanide ions (Ln³⁺) in the core.

Lanthanides are the rare earth elements, ranging from Lanthanum (La, Z=57) to Lutetium (Lu, Z=71) in the periodic table. A characteristic feature of the lanthanide (Ln³⁺) ions is the presence of sharp lines in their optical emission spectra. These sharp lines were ascribed to the transitions within the 4f shell of lanthanide ions (intraconfigurational 4fⁿ transitions). Electrons in the 4f shell of lanthanide ions are shielded from the surroundings by the electrons in the 5s and 5p shells, and hence the 4f electrons are not involved in the chemical bonding between the lanthanide ion and the surrounding ligands or counterions, sharp emission lines are observed when the lanthanide ion is excited with a visible or ultraviolet light.

Several possible mechanisms were suggested for the 4fⁿ transitions: the forced electric dipole (ED) mechanism, the electric quadrupole (EQ) mechanism and the magnetic dipole (MD) mechanism. It was shown that the EQ contribution is too weak to be responsible for the 4fⁿ transitions and that contribution of the MD mechanism is important only in some cases. In most cases the ED mechanism is the dominant one. In first approximation, the electric dipole transitions are parity forbidden, but due to the admixture of the opposite parity states (like 4fⁿ⁻¹5d or charge transfer states) these transitions can become allowable.

OLEDs are typically fabricated on a transparent substrate coated preliminary with the hole-injecting electrode. Usually, indium-tin-oxide (ITO) is used as the hole-injecting electrode, which forms transparent and electro-conductive anode layer. One or more organic layers are coated then by either thermal evaporation (in case of small organic dye molecules), or by spin coating in case of polymers. In addition to the active layer of the luminescent material itself, other organic layers may be used to enhance injection and transport of electrons and/or holes. Metal cathode (such as magnesium-silver alloy, lithium-aluminum or calcium) is deposited on the top of the multi-layer structure using the high-vacuum sputtering technique. These metals are chosen for their low work functions in order to provide efficient injection of electrons. Total thickness of organic layers is about 100 nm. Two electrodes (e.g. ITO anode and metal cathode) add about 200 nm to the total thickness of the device. Therefore the overall thickness (and weight) of the OLED structure is determined mostly by the substrate.

The proposed invention suggests the construction of active layer of OLED comprising special dendrimers with Ln³⁺ locus. It is based on new idea taking advantage of several findings in the field: the antenna effect, the shell effect, and the energy transfer from dendrimer triplet state to the Ln³⁺ locus (4f shell) ct. Only special design of structure and electron leveles of the dendritic molecules mentioned above leads to the effective OLED of this invention.

### OBJECTIVES AND SUMMARY OF THE INVENTION

It is an objective of the present invention to improve performance of organic light emitting devices by special smart design of the active layer material.

Another objective of the invention is to provide simple and efficient method for smart design of the active layer.

Another objective is to provide an efficient choice for electrodes providing effective injection of electrons from low-work function anode.

A further objective is to reduce operating voltage and to improve overall efficiency of the OLED device.

Still another objective of the invention is to improve thermal stability and operation life time of the OLED.

Briefly stated, the present invention provides a method for fabrication of efficient organic light emitting devices, including OLED displays and OLED for general lighting applications. The method is based on special design of the light emitting active layer comprising dendrimers with lanthanide Ln³⁺ ions as the locus, which possess high light emitting efficiency and energy accepting properties and determine the emitted light color, and the periphery, which possess high excitation efficiency and energy donating properties. The periphery of the dendrimer active layer of present invention also demonstrates high efficiency of collecting charge carriers, electrons and holes, producing excited states via recombination process with further electronic excitation energy transfer from the periphery to the dendrimer locus followed by energy conversion into the emitting light.

The proposed approach has a number of advantages with respect to known OLED devices:

1). The color of light emission can be controlled by proper selection of the locus ions, whereas the special surface groups can provide a good solubility, which is necessary for spin cast fabrication of the sandwich devices;

2). Ln³⁺ ions are surrounded by the dendritic shell preventing aggregation and luminescence self-quenching;

3). The dendritic branches are designed to have a HOMO-LUMO energy gap value close to the 4f energy level of the lanthanide ion locus, providing a vectorial charge and exciton transfer towards the light emitting center placed in the dendritic locus;

4.) Energy transfer by the Dexter energy exchange mechanism between the triplet states of the periphery and the 4f orbitals of the Ln³⁺ locus allows increasing significantly the device efficiency;

5). Dendrimer structure provides the light emitting stability of the OLED device. Dendrimer chemical structure prevents processes of chemical decomposition, oxidation and cross linking followed by decrease of the light emitting efficiency.

The method can be used in all applications where highly efficient LED are required, including organic LED displays and general lighting

### BRIEF DESCRIPTION OF DRAWINGS

FIG. 1. Schematic illustration of singlet and triplet states and energy transfer to the Ln core.

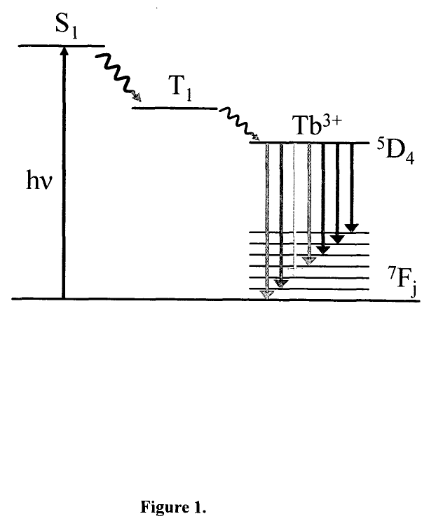

FIG. 2. Example of dendritic structure.

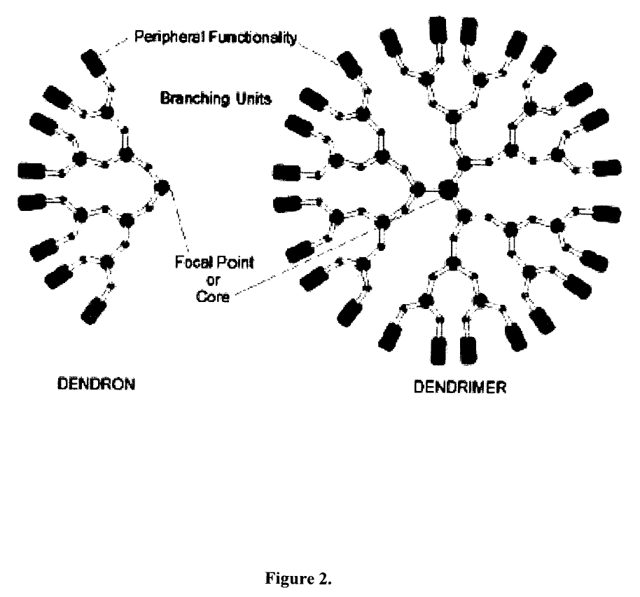

FIG. 3. Illustration of the antenna effect

FIG. 4. Structural design of the dendrimer based OLED with Ln³⁺ ions in the locus.

FIG. 5. Synthesis of poly-p-perfluorophenylene-silane (PPS, E=Si) and poly-p-perfluorophenylene-germane (PPG, E=Ge). Fluorine atoms in the dendrimer structure are omitted for clarity.

FIG. 6. Poly-p-perfluorophenylene-germane (PPG) dendrimer with Ln³⁺ ions in the cavities, which is used as a material of the OLED active layer.

FIG. 7. Di-phthalocyanine-terbium complexes formulas.

FIG. 8. Tb(Sal)₃ complex formula.

FIG. 9. 1,3,5-triarylbenzene Ln-hyperbranched molecule formula.

FIG. 10. I-V characteristics of the fabricated OLED.

FIG. 11. Example of the multilayer structure of working device.

### DESCRIPTION OF PREFERRED EMBODIMENTS

The proposed invention suggests special construction of active layer of OLED comprising dendrimers with Ln³⁺ locus. It takes advantage of new idea based on several findings in the field: the antenna effect, the shell effect, and the effect of energy transfer from periphery to the Ln³⁺ locus. Only certain structural combination of the dendritic molecules mentioned above leads to the effective OLED of this invention.

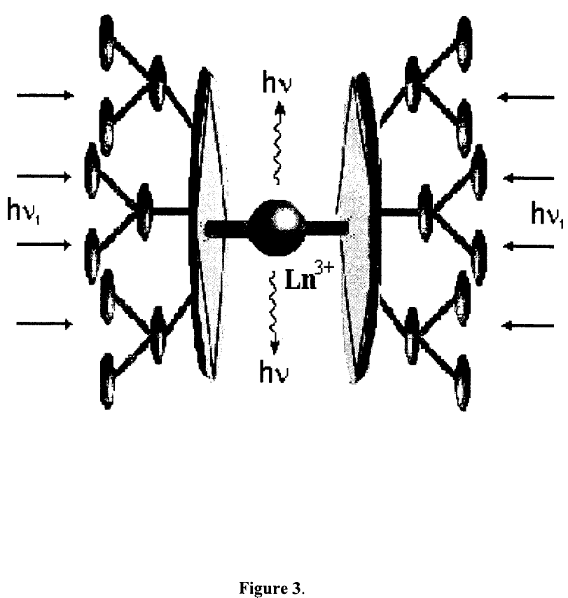

The Antenna effect. New family of chromophore-labeled dendrimers designed for use in single-layer light-emitting diodes were reported by Frechet and co-workers. These dendrimers were composed of the peripheral redox-active triarylamine (TAA) fragments, the core fluorophores and the accompanying electron transporting oxadiazole, 2-(4-biphenyl)-5-(4-tert-butylphenyl)-1,3,4-oxadiazole moieties. Since both the dendrimer backbone and the core fluorophores had comparatively high redox potentials, charge transport was expected to occur solely through the hole-transporting TAA moieties. Transfer of energy to the highly luminescent acceptor fluorophores at the core of the dendrimer via a Förster process, subsequently resulted in the emission exclusively from the acceptors. Related dendrimer-based OLEDs have been reported recently by Devadoss, Bharathi, e.a. In these works the Förster energy transfer from charge carriers on the periphery of the dendrimer to a fluorescent dye at the core demonstrated the antenna effect (FIG. 3).

The Shell effect. The dendritic architecture provides a way to control the intermolecular interactions: in a high-generation dendrimers only surface groups and/or outer branches can contact with each other. This could help to solve the problems related to the aggregation and the luminescence self-quenching phenomena, which was observed in polymeric and molecular luminescent materials. New conjugated light-emitting dendrimers for OLED applications based on the phenylenevinylene structures were reported by Samuel, e.a. The effect of dendrimer generation number on photophysical and electroluminescence properties was demonstrated for these materials. The dendrimers were composed of a distyrylbenzene core (for the short wavelength emission), stilbene dendrons (for the charge transport), and t-butyl substituents as surface groups for good processing. All three generations could be spin-coated from chloroform into thin films of optical quality. The dendrimers, at the first sight, appeared to be fully conjugated. However, as the links at the branching phenyls were in the meta position in the arrangement, each of the conjugated units could be considered in the first approximation, as electronically independent.

The Energy transfer effect. The luminescence enhancement of Tb³⁺ ions bound to the amphiphilic linear-dendritic block copolymers [poly-(acrylic-acid)-dendritic polyether, PAA-Dendr.PE] was investigated by group of Dr. Linyong Zhu. Tb³⁺ ions were coordinated with a PAA chain of the block copolymer, forming a supramolecular luminophore. The observed prominent enhancement in luminescence properties was attributed to two important factors. The antenna effect leads to a remarkable enhancement of the luminescence intensity of Tb³⁺ ions, which was increasing obviously with the dendrimer generation number.

The present invention suggests special design of highly emissive dendrimers for OLED with lanthanide (Ln³⁺) ions (for example, Eu³⁺/Tb³⁺) in their core providing efficient light harvesting similar to bacteriorhodopsine and other natural photosynthetic systems. The proposed design has a number of advantages with respect to known electro-luminescence devices. Color of the light emission can be controlled by proper selection of the core, whereas special surface groups can provide good solubility of the material, which is extremely important for spin cast fabrication of the sandwich devices. In order to prevent lanthanide (Ln³⁺) aggregation leading to self-quenching processes the Ln³ ions are surrounded by dendritic shell. The dendritic branches are designed such to have a HOMO-LUMO energy gap near 4f energy level of the lanthanide core, providing a vectorial charge and exciton transport towards the light emitting center placed in the dendritic core. The energy transfer by the Dexter energy exchange mechanism from triplet states of the periphery to Ln³⁺ core ensures high light emitting efficiency of the device.

Specific preferred embodiments of the invention are described below in detail. It must be understood that these embodiments are included only as illustrative examples and the invention is not limited thereto.

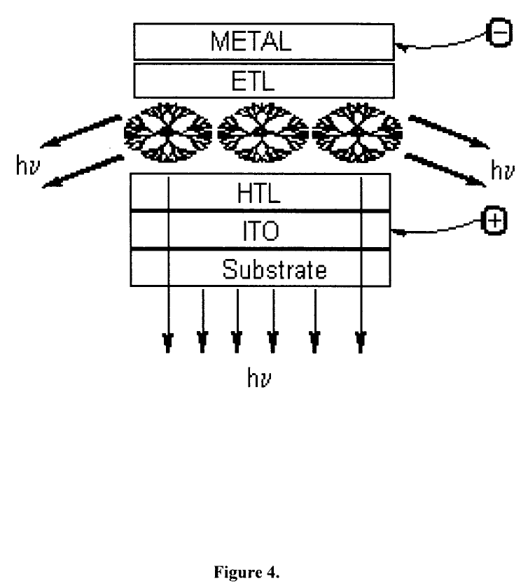

One of the preferred embodiments of the present invention is depicted on FIG. 4. The top metal electrode is the source of electrons and the ITO anode layer, covering the transparent substrate, is the holes injector. Material for the active layer must be designed according to the principles described above in this patent.

Embodiment of the Active Layer Materials

Representative embodiment of the present invention include the following materials that can be used for fabrication of the active layer of an OLED:

1. Dendrimer Materials Based on Poly-perfluorophenylene-silanes and Poly-perfluoro-phenylene-germanes

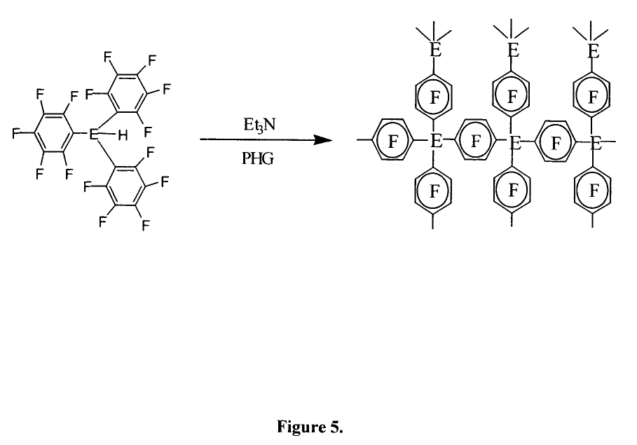

Perfluorinated poly-p-phenylene-silanes (PPS) and poly-p-phenylene-germanes (PPG) were synthesized by anionic polymerization of tris(perfluorophenylene)-silane or similar germane derivative in PPG, using triethylamine (Et₃N) as a catalyst. Complete fluorination of the aromatic rings attached to the silicon or germanium species allowed formation of the active anions via silicon (germanium) deprotonation by Et₃N with further nucleophilic displacement of the fluorine atoms in para positions of the perfluorinated benzene rings yielding dendritic structures that are soluble in polar and aromatic solvents (FIG. 5).

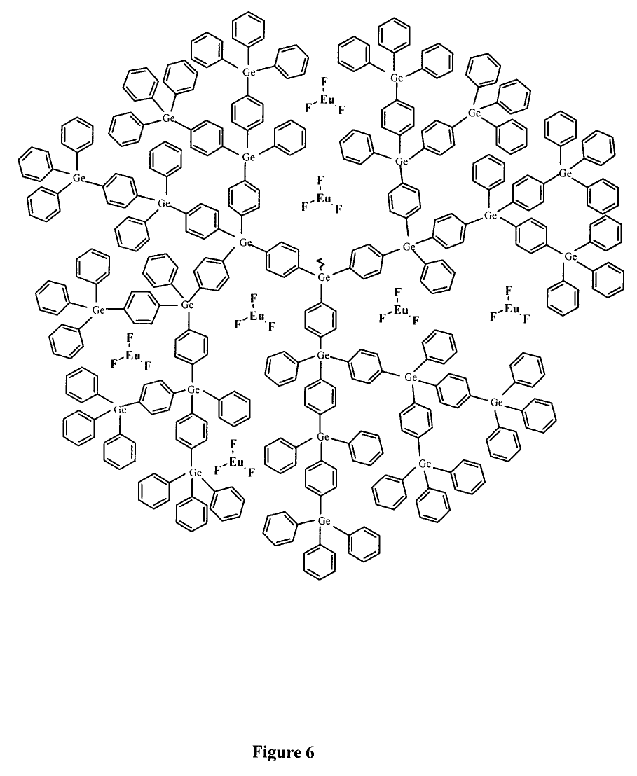

PPS and PPG hyperbranched dendrimers can be used to prepare guest-host composites as materials for the active layer of OLED devices and lanthanide salts LnF₂ or LnF₃ as guest molecules. An example of the structure of the guest-host material based on PPG dendrimer is presented in FIG. 6.

Organometallic complexes of lanthanides can be used to prepare guest-host composites based on PPS or PPG dendrimers. For example, synthesis of PPG in the presence of naphthalene-europium-THF complex produces PPG based guest-host composite material, containing europium ions:
(C₆F₅)₃GeH+C₁₀H₈Eu(THF)₃→{[(C₆F₄)₂Ge(C₆F₄)]ₓ[EuF₂]_{y}}+C₁₀H₈
Application of the similar guest-host systems, in which the guest molecules are coordinated with the chelating N-containing ligands, such as 2,2′-bipyridine (bipy), also produces the desired composite materials. Two different synthetic routs can be used in this case to prepare these compounds: (i) synthesis of PPS (PPG) dendrimer in the presence of Ln(bipy)₄ complex—is the first one, and (ii) treatment of the PPS (PPG)—lanthanide composite, synthesized via organometallic complexes of lanthanoids (see above) with free bipy, is the second one:
(C₆F₅)₃SiH+Eu(bipy)₃→{[(C₆F₄)₂Si(C₆F₄)]ₓ[EuF₂(bipy)]_{y}}+2 bipy (i)
{[(C₆F₄)₂Ge(C₆F₄)]ₓ[EuF₂]_{y}}+bipy→{[(C₆F₄)₂Ge(C₆F₄)]ₓ[EuF₂(bipy)]_{y}} (ii)
2. Dendrimer Materials Based on Tb-phthalocyanine Derivatives

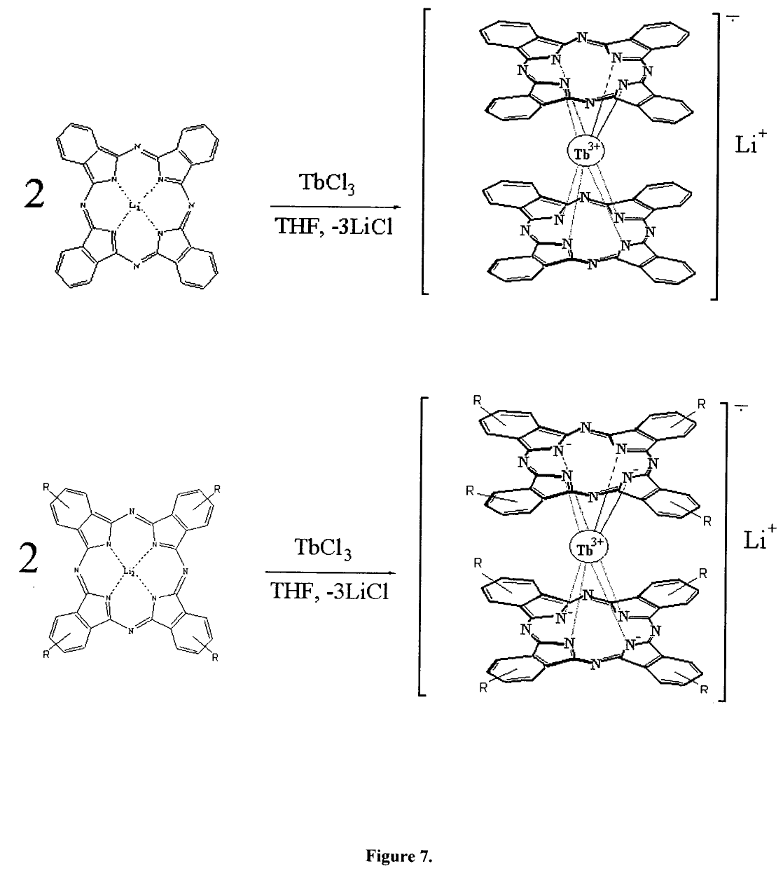

Reaction of di-lithium-phthalocyanine and terbium tri-chloride can be used to synthesize terbium(3+)-di-phthalocyanine complexes (PC₂Tb) (FIG. 7).

Three-neck round bottom flask with magnetic stirrer, nitrogen inlet and dropping funnel was charged under nitrogen with 0.265 g (1 mM) of anhydrous terbium (III) chloride (Aldrich, 99.9%). 25 ml of carefully dried THF was added to produce slurry at the intensive stirring. Solution, prepared in the separate flask from 1.5 g of di-lithium-phthalocyanine in 25 ml THF, was added slowly to this slurry and was stirred overnight at room temperature. The reaction solution was filtered in the inert atmosphere and THF was evaporated in vacuum. The dark-blue solid was dissolved in hot toluene and produced dark-blue crystalline product [Tb³⁺(PC²⁻)₂]Li⁺ overnight (0.61 g), which appeared as a dark-blue paramagnetic crystalline material. Similar reaction can be used to prepare phthalocyanine complexes of lanthanoids with different hyperbranched substituents (FIG. 7).

3. Dendrimer Materials Based on Tb(Sal)₃(TPPO)₂ Complex

A novel mixed-ligand complex, Tb(Sal)₃(TPPO)₂, have been studied to characterize thermal stability and electroluminescent properties of this complex. Tb(Sal)₃(TPPO)₂ possesses extremely high solubility in ethanol, benzene, THF and was used as an emitter layer for fabrication of an electoluminescence device.

Terbium oxide Tb₄O₇ (99.99%) was converted to the nitrate by treating with concentrated nitric acid. Salicylic acid (HSal) and triphenylphosphine oxide (TPPO) were purchased from Aldrich Chemicals and used without further purification.

Tb(Sal)₃.H₂O was prepared according to the standard method: 1 mmol Tb(NO₃)₃.6H₂O was dissolved in ethanol and added dropwise under stirring to the ethanol-aqua solution of 3 mmol Na(Sal) (synthesized from HSal and NaOH). The reaction mixture was heated to obtain the white precipitate. It was then filtered off, washed with water and dried in vacuum at 60° C.

Anal. Calcd. for C₂₁H₁₇O₁₀ Tb: C, 42.85; H, 2.89; Tb, 27.0; found: C, 42.83; H, 2.83; Tb, 26.6%. IR, cm⁻¹: 3285 (ν O—H); 3061 (ν C—H); 1660-1710 (δ H₂O); 1548, 1565 (νₐₛ COO⁻).

Tb(Sal)₃(TPPO) and Tb(Sal)₃(TPPO)₂ were synthesized in the normal way by the interaction of Tb(Sal)₃.H₂O and TPPO in an ethanol-benzene mixture (1:1) in a 1:1 and 1:2 mole ratio, respectively. The solution has been refluxed for 1 h and then cooled to room temperature. The azeotrope of benzene-ethanol, benzene-water and excess of the solvent were removed from the reaction mixture. The resulting solid was dried in vacuum at 60° C.

IR for TPPO, cm⁻¹: 3051 (ν C—H); 1590, 1483 (benzene ring); 1438 (δ P—C₆H₅); 1192 (ν P═O). Anal. Calcd. for C₃₉H₃₀O₁₀P Tb: Tb, 18.7%; found: Tb, 18.5%. IR, cm⁻¹: 3062 (ν C—H); 1594, 1484 (benzene ring); 1544-1563 (νₐₛ COO⁻); 1438 (δ P—C₆H₅); 1155 (ν P═O).

Anal. Calcd. for C₅₇H₄₅O₁₁P₂ Tb: Tb, 14.1%; found: Tb, 14.2%. IR, cm⁻¹: 3060 (ν C—H); 1595, 1485 (benzene ring); 1561 (νₐₛ COO⁻); 1438 (δ P—C₆H₅); 1158 (ν P═O).

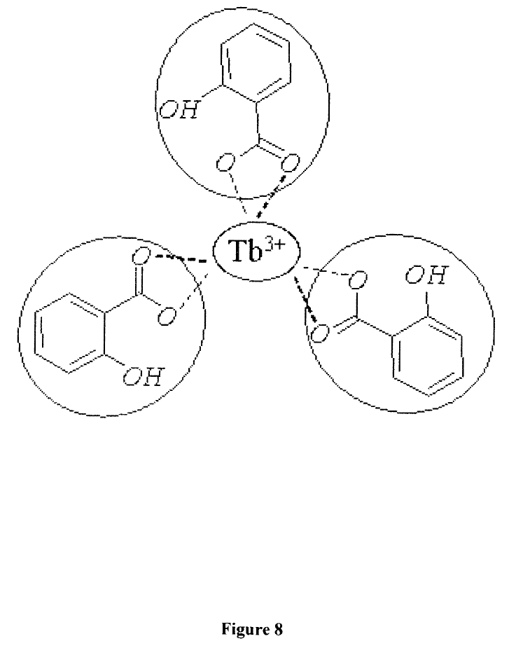

Structural formula of the complex is shown in FIG. 8.

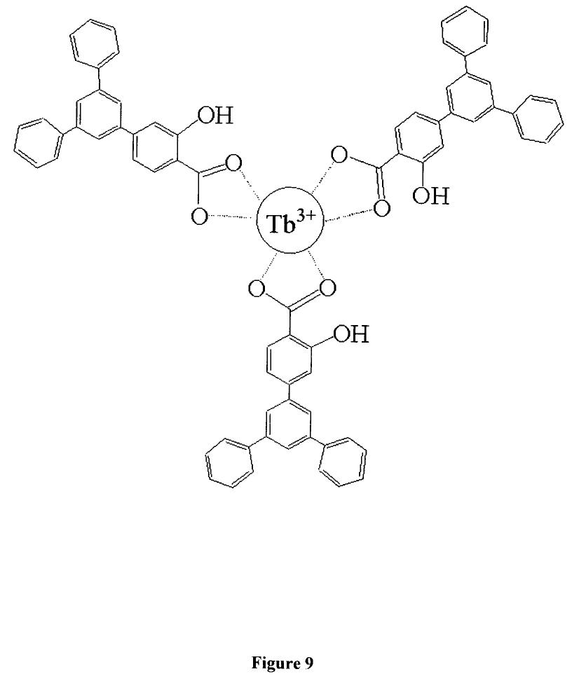

Similar procedures can be used to prepare branched and dendrimer materials, like terbium complexes, with structure presented in FIG. 9.

Fabrication of the OLED Devices.

OLEDs were fabricated using known procedures but employed a specially designed active layer. Instead of using a standard active layer produced from polymer or other organic small molecule materials, our active layer was produced from materials of dendrimer structure having the periphery of specific chemical structure described above and lanthanide ions in the locus. The commercially available ITO/Borosilicate substrates had thickness of ITO layer of about 150 nm. The electron transfer layer (ETL), the active layer and the hole transfer layer (HTL) at a thickness of about 150 nm each were deposited by spin coating or in a standard high vacuum chamber at pressures of 10⁻⁶ torr as appropriate.

In a preferred embodiment of the present invention, materials that are used as the cathode layer of an OLED include metals with a low work function, for example: Al, Al/Li, Ca, Mg/Ag. Such metallic cathode layers provide an electrically conductive path for current flow serving to inject electrons into the electron transfer layer.

In another preferred embodiment of the present invention, materials that are used as the electron transfer layer of OLED are selected on the basis of the difference between its ionization potential (IP) and the energy gap between the highest occupied molecular orbital and the lowest unoccupied molecular orbital (HOMO/LUMO) value for this material. This difference for the ETL material should be equal or less than the same IP-HOMO/LUMO difference of the dendrimer material of the active layer. Otherwise energy barrier to electron flow from the electron transfer layer into the active layer will not allow the device to work efficiently. Similar guidelines should be applied to the selection of the hole transfer layer. A list of compounds that can be used for HTL and ETL is shown in the Table 1 below.

TABLE 1
List of compounds for HTL and ETL.

| Hole Transfer Layer (HTL) | Electron Transfer Layer (ETL) |
|---|---|
| PPEI - Perylene-phenethylimide | TiOPC - Titanylphtalacyanine |
| p-EFTP aminobenzene derivative | PBD - Tetraphenylbenzidine deriva- |
| | tive |
| PTD-BC-poly(9-tetradecanyl- | HBPC - hyperbranched polycarbazole |
| 3,6,(dibutadiynyl)-carbazole | |
| α-NPD-4,4′-bis-[N-(1-napthyl)-N- | TAZ-3-(4-biphenylyl-4-phenyl-5- |
| phenyl-amino] biphenyl | (4-tert-butylphenyl)-1,2,4-triazole |
| TPD-tetraphenylbenzidine | PBP |
| derivative | |

The fabricated devices were characterized by measuring their current-voltage, luminance-current, electroluminescence spectra and the transmission, reflection and absorption spectra.

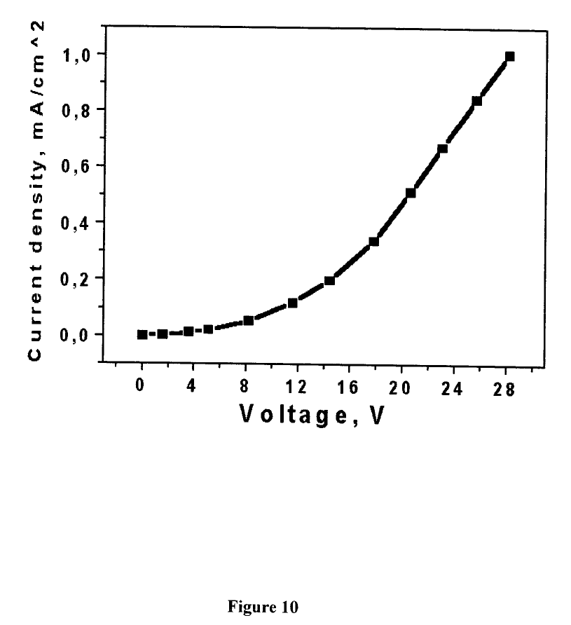

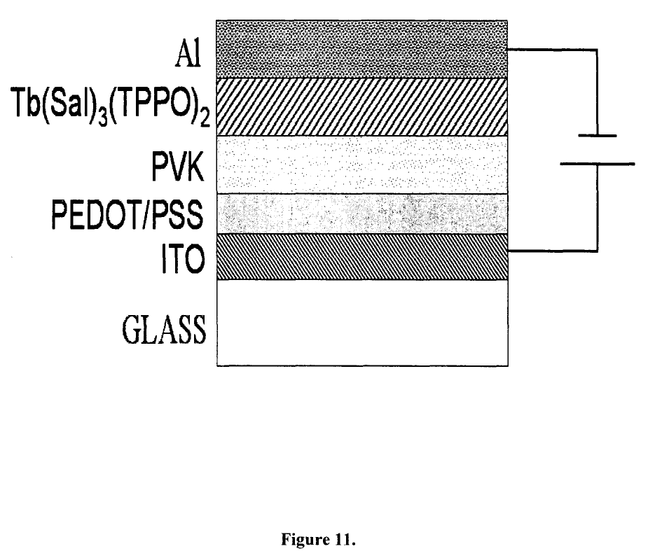

The Eu—PPG (or TbSal₃ TPPO₂), (as example) patterned electrode was attached to chip carrier by silver paste. The electrode and external probes were connected by wire bounder. Constant voltage was supplied by Keithly unit, and resulting current was measured by similar unit. The noise level during I-V measurements was tens pA, while the signal level was hundreds nA. Typical I-V characteristic of the working sample of ITO/TbSal₃ TPPO₂/Al device is depicted in FIG. 10. FIG. 11 schematically shows structure of the multilayer LED device.

ITO-coated glass was cut into 2×2 cm pieces and etched using zinc dust and hydrochloric acid. The substrates were then washed in ultrasonic bath sequentially in sodium hydroxide and ethanol mixture and deionized water. A PEDOT hole transport layer was then spin-cast from water solution of PEDOT/PSS mixture with gamma-Glycidoxypropyltrimethoxysilan (Silquest A 187 Epoxysilan from Witco) added for better adhesion and film stability. The film was dried on a hot plate to crosslink the Epoxysilan at 110° C. for about 20 min. Organic layers were then spin-cast on the substrate. The 5 g/l solutions of PVK in toluene and Tb(Sal)₃(TPPO)₂ in tetrahydrofuran were used for spin-coating the buffer and active layers, respectively. The Al electrodes were thermally evaporated under a base pressure below 3·10⁻⁵ mbar. Contacts were attached to the electrodes, and the device was sealed with epoxy resin. The emitting areas were 2×3 mm. The multilayer device is shown schematically in FIG. 11.

Having described preferred embodiments of the invention with reference to the accompanying drawings, it is to be understood that the invention is not limited to the precise embodiments, and that various changes and modifications may be effected therein by skilled in the art without departing from the scope or spirit of the invention as defined in the appended claims.

1. Electroluminescence light emitting device having multilayer structure deposited on a transparent substrate comprising of
an active light emitting layer,
a hole injecting electrode,
a hole transfer layer,
an electron injecting electrode, and
an electron transfer layer,
said active light emitting layer comprises of organic or organometallic materials, having a locus with good energy accepting properties and high light emitting efficiency embedded into a periphery with high electronic excitation and energy donating properties, collecting electron and hole charge carriers producing excited states via the electron-hole recombination process followed by electronic excitation energy transfer from the periphery to the locus (antenna effect) and converting the energy into the emitting light, wherein
said locus comprises of lanthanide ions (Ln³⁺) in the 3+ oxidative states with electron structure and electron transitions selected such to determine required emitting wavelength with narrow spectral band,
said periphery has hyperbranched dendrimer-like architecture having specific electronic structure providing efficient energy transfer from triplet level of the periphery, that is efficiently excited via electron-hole recombination to 4f orbitals of the locus, and ensuring spatial separation of the light emitting locus centers preventing concentration self-quenching of their luminescence light emission (shell-effect).

2. Electroluminescence light emitting device of claim 1, wherein said active light emitting layer comprises of light harvesting dendrimers, including dendrimers with pyrenyl and naphthyl groups on the periphery, phenylacetylene-based dendrimers, porphyrin dendrimers bearing Frechet's poly(aryl ether) wedges, homonuclear Ln³⁺-based dendrimers, dendrimers with four binuclear building blocks, dendrimers with bis(4-pyridine-2,6-dicarboxylic acid) derivatives, embedded in a highly conductive polymer matrix, such as poly-p-phenylene (PPP), poly-p-phenylenevenylene (PPV), poly-vynil-carbazole (PVC) and their derivatives or in other conductive polymer matrixes, providing the electron-hole recombination on an external dendrimer shell with consequent energy transfer to said locus by one- or multi-step processes.

3. Electroluminescence light emitting device of claim 1, wherein said active light emitting layer comprises of a π-electron dendrimer, such as, rubrene-doped N,N′-diphenyl-N,N′-bis(3-methylphenyl)-[1,1′-biphenyl]-4,4′-diamine (TPD), tris(8-quinolinato)aluminum, hyperbranched polycarbazole derivatives, cumarin-based hyperbranched polymers starting with 3-carboxycumarin, polyamide dendrimers containing electron-deficient 5-membered oxadiazole units, providing the electron-hole recombination inside the dendrimer with consequent energy transfer to said locus.

4. Electroluminescence light emitting device of claim 1, wherein Tb³⁺ ions are used as said locus.

5. Electroluminescence light emitting device of claim 1, wherein Eu³⁺ ions are used as said locus.

6. Electroluminescence light emitting device of claim 1, wherein Sm³⁺ ions are used as said locus.
